(19) United States
(12) Patent Application Publication
(10) Pub. No.: US 2009/0183409 A1
(43) Pub. Date: Jul. 23, 2009

(54) Tent Sign Apparatus And Method

(75) Inventors: Timothy Jon Thomas, Franklin, TN (US); David C. McFerrin, Sparta, TN (US); Paul F. Morgan, Cookeville, TN (US)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(73) Assignee: IDG, LLC, Cookeville, TN (US)

(21) Appl. No.: 12/016,853

(22) Filed: Jan. 18, 2008

(51) Int. Cl. G09F 15/00

(52) U.S. Cl. 40/610

(57) ABSTRACT

An A-frame sign apparatus in which a panel includes a recessed portion for receiving a signage plate containing a message for display to passers-by and a support attached to the panel for selectively positioning at an oblique angle relative to the panel to standing the A-frame sign apparatus on a surface. A method of selecting the signage plate from a plurality of pre-designed signs accessible by a computer and printed on a local printer is disclosed.

### TECHNICAL FIELD

The present invention relates to a signage apparatus. More particularly, the present invention relates to apparatus with selectively changeable signs and an interactive system for generating signs to be used with such apparatus.

### BACKGROUND OF THE INVENTION

Office buildings, lobbies, shopping centers, and other places which are used by persons often have need for temporary signs. These signs generally are used to alert passers-by to a temporary condition or building status apart from the normal or expected condition or status. The signs thus act as alerts or warnings for persons to be aware of a change to the area. For example, a cleaning crew after mopping or polishing a floor may post a temporary sign to alert persons that the floor is wet. Other temporary signs may include directional signals for room locations for events, for construction activities, or other temporary condition-changed events requiring notice or alerts to persons.

Various signage devices are available for use in alerting persons to changed circumstances. These include handwritten signs as well as commercially available pre-prepared signs. “Tent” signs are one type of such pre-prepared signs known in the trade. Tent signs have opposing panels that pivotally connect along an edge. The panels pivot apart to form a wide base and stand on the floor in an inverted “V” shape with the apex pointing away from the floor or an “A-frame” shape. Such signs are convenient, temporary, and preprinted with a warning or alert message.

The preprinted message or warning; however, may be unsatisfactory for the particular condition. A preprinted sign having an appropriate text or graphics for the particular condition; however, may not be available. Also, it is impractical to have a number of different preprinted signage for various conditions that may not occur. Such additional signs occupy space for storage and incur capital costs for acquisition.

Accordingly, there is a need in the art for sign apparatus that is readily configured with appropriate messages for selective temporary alerting to passers-by. It is to such that the present invention is directed.

### SUMMARY OF THE INVENTION

The present invention meets the needs in the art by providing a selectively configured temporary sign apparatus for displaying information, comprising a panel having a front and an opposing back, a bottom edge and a top edge, with the panel including a recessed portion for receiving a signage plate and defining at least one opening therein for facilitating removal of the signage plate therefrom. A support attaches to the panel and can be selectively positioned at an oblique angle relative to the panel for standing the sign apparatus on a support surface.

In another aspect, the present invention provides a signage system comprising a computerized sign selection apparatus having a database with a plurality of pre-designed signs for selection by a user communicating from a computer through a network. Printer means provides for generating a sheet bearing the selected sign. The system includes a sign holding device comprising a panel having a front and an opposing back, a bottom edge and a top edge. The panel includes a recessed portion for receiving the sheet bearing the selected sign and defining at least one opening therein for facilitating removal of the sheet therefrom. A support attaches to the panel and is selectively positioned at an oblique angle relative to the panel for standing the sign holding device on a support surface. The sheet bearing the selected sign is disposed within the recessed portion and the sign holding device positioned on the support surface displays the selected sign.

In another aspect, the present invention provides a method for displaying a sign, comprising the steps of:

(a) selecting a sign from a plurality of pre-designed signs contained on a database that is accessed by a user having a computer that communicates with the signage database;

(b) printing on a local printer at least one copy of the selected sign;

(c) inserting the printed copy of the sign into a recessed portion of a panel;

(d) positioning a support attached to the panel so that the panel stands in an erected position on a support surface for display of the printed sign in proximity to an area of relevance to the printed sign.

Other objects, features, and advantages of the present invention will become apparent upon reading the following detailed description in conjunction with the drawings.

### BRIEF DESCRIPTION OF THE DRAWINGS

FIG. 1 is a perspective exploded view of the tent sign according to the present invention.

FIG. 2 is a schematic illustration of the sign generator system used with the tent sign device illustrated in FIG. 1.

### DETAILED DESCRIPTION

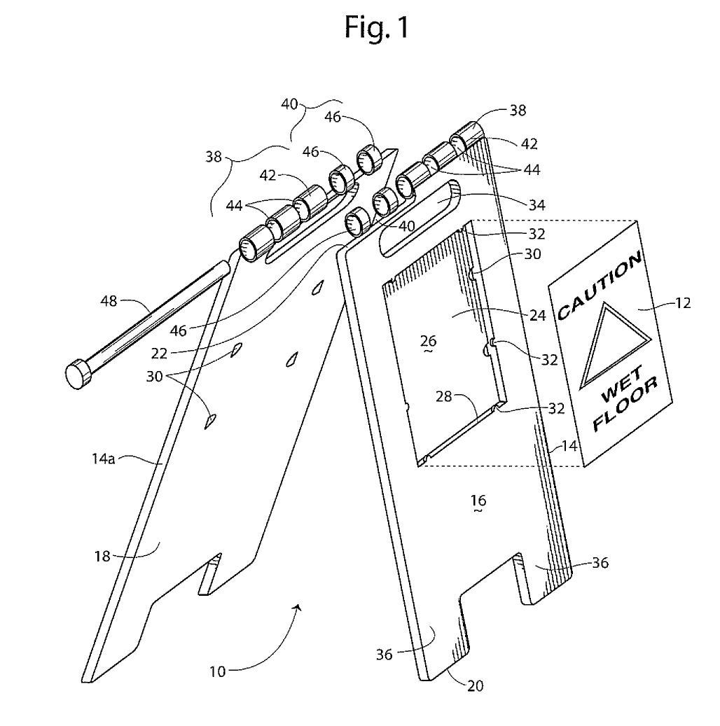

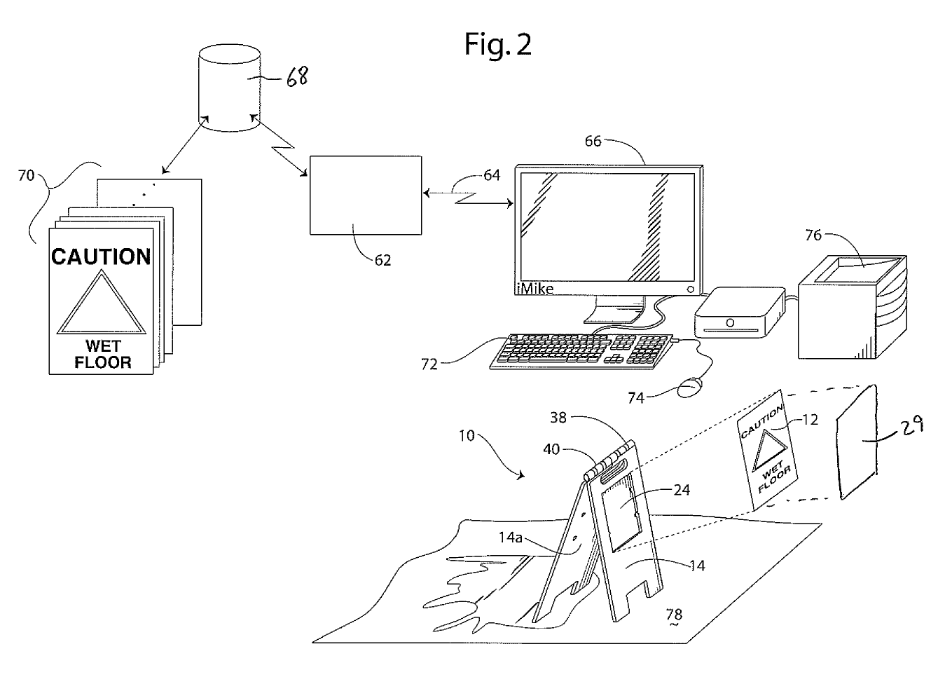

With reference to the drawings in which like parts have like reference numerals, FIG. 1 illustrates in respective exploded view a sign apparatus 10 for display of a selected sign 12 in accordance with the present invention. The sign apparatus 10 includes a panel 14 having a front 16 and an opposing back 18, with a bottom edge 20 and top edge 22. The panel 14 includes a recessed portion 24 having a recessed bottom 26 and sidewalls 28. The recessed portion 24 is sized for selectively receiving the printed sign 12, for example an 8½×11 inch printed sheet or sign board Selectively, a transparent sheet 29 illustrated in FIG. 2 overlies the sign 12 within the recessed portion 24 to shield the sign during use of the tent sign 10, such as from water or from marking by others.

With continuing reference to FIG. 1, the recessed portion 24 defines at least one opening 30 accessible though the back 18. The opening 30 facilitates pushing against the printed sign 12 held in the recessed portion 24, for removal of the printed sign from the recess, as discussed below. The illustrated embodiment provides a pair of spaced-apart openings 30.

The panel 14 further comprises at least one tab 32 that projects over the recessed bottom 24. The tab 32 extends from an edge of the portion of the panel 14 that defines the recess portion 24. The tab 32 is spaced-apart from the recessed bottom 26 to define a gap. A side portion of the printed sign 12 extends into the gap so that the sign is secured or held by the tab 32 in the recessed portion 24. The illustrated embodiment includes a pair of laterally extending tabs on lateral side walls of the recessed portion 24. The illustrated embodiment also includes two pairs of tabs extending from the opposing top and bottom walls of the recessed portion 24.

A slotted opening 34 in a portion of the panel near the top edge 22 cooperatively defines a handle whereby the panel can be carried for selective positioning on a support surface such as a floor requiring a sign to alert passersby to changed conditions or other information displayed on the sign apparatus 10.

The panel 14 stands in an erected inverted “V” or “A-frame” orientation by positioning a support at an oblique angle relative to the panel on the support surface. In the illustrated embodiment, the support is a second panel 14a that likewise includes the recessed portion 24 for receiving a second one of the printed signs 12. In this manner, the information displayed on the sign 12 can be presented in two opposing directions. In an alternate embodiment, the support is an elongated member attached to a portion of the back 18 of the panel 14.

A bottom portion of the panel 14 in the illustrated embodiment defines spaced-apart feet generally 36. It is to be appreciated that other ornamental configurations can be provided, so that the bottom edge 20 is in contact with the support surface for standing the sign apparatus 10 for display of information.

The top edge 24 is particularly configured for hingedly connecting the sign panels 14 and 14a. This is accomplished by the top edge 22 including a first hinge portion 38 and a second portion 40. The respective hinge portions 38, 40 matingly engage opposing hinge portions 40, 38 of the panel 14a. In the illustrated embodiment, the first hinge portion 30 is an elongate cylinder 42 with a pair of spaced-apart slots 44. The second hinge portion 40 includes a pair of spaced-apart projecting loops 46. The loops 46 are sized for being received in the slots 44 of the first hinge portion 38 of an opposing panel 14. A pin 48 passes axially through the first and second portions for connecting the matingly engaged hinge portions 38, 40 of the panels 14 and panel 14a. In an alternate embodiment, the loops 46 have shoulders that engage receiving portions of the loops in the circular slots 44 of the cylinder 42. Other hinging connections can be readily provided so that the tent sign 10 can stand on a surface.

The sign apparatus 10 of the present invention is particularly useful in a sign generating system 60 schematically illustrated in FIG. 2. The system 60 includes an interactive site 62 such as a computer or a computerized web site that communicates by a network 64 with at least one remote user having a stand-alone computer 66. The interactive site 62 maintains an accessible database generally 68. The database 68 includes a plurality of pre-designed signs 70. One of the plurality of signs 70 can be selected as discussed below for use as the printed sign in the sign apparatus 10. In an alternate embodiment, the database is maintained on the computer 66 and is accessible through software operated on the computer.

The user computer 66 is conventional, and includes a display 72, input devices such as a keyboard 74 and mouse 76 or other conventional input devices. The computer 66 communicates with a local printer 76.

In operation of the sign generating system 60, the user communicates through the computer 66 via the network 64 with the interactive site 62. The site 62 displays the available plurality of pre-selected sign 70, such as caution, advisory, warning, alert, graphics, directional, informational, or other such sign. The user selects one, or more, of the pre-designed signs 70 for printing on the local printer 76. The sign 12 printed on the local printer 76 is then readily inserted into the recessed portion 24 of the sign apparatus 10. As noted above, the transparent sheet 29 readily inserts into the recessed portion 24 over the sign 12 for protecting the sign during usage. In an alternate embodiment, the sign 12 is printed on water-resistant sheets, or is covered with an adhesive-back cover.

The sign apparatus 10 is then placed on a support surface 78 of an area to alert passersby as to relevant information. In one aspect, the pre-printed signs include one or more fields that can receive user-supplied information, such as the name of the building or space for which the sign is to display information, or other site-specific information. The sign selection system 60 provides interactive communication with the user to request and receive the user-supplied information. The pre-designed signs 70 can be in various languages, directed to a variety of problems (for example, and without limitation, wet floors, lighting, early closing, directional changes, or other conditions for which information to passers-by would be useful.)

After selection and printing on the local printer 76, the sign plates 12 are inserted into the recessed portion 24. Side portions of the sign plates 12 insert into gaps between the tabs 32 and the bottom 26 of the recessed portion 24. The sign apparatus 10 is then carried, such as with the handle formed by the slotted opening 34, to the location at which the sign is to be placed. The plates 14 and 14a pivot apart from a collapsed position with the plates planarly together to define an oblique angle so that the feet 36 sit on the ground with the sign apparatus forming an inverted “V” or “A-frame” shape.

The sign plate 12 is removed from the recessed portion 24 by pushing, for example, fingers, through the openings 30. This causes the sign plate 12 to move outwardly, and the sign plate can then be grasped by the hand and removed from the recessed portion.

The panel 14 of the sign apparatus 10 is readily manufactured of molded plastic or other material, such as recycled plastics.

While this invention has been described in detail with particular reference to an illustrated embodiment thereof providing a sign assembly that readily receives a selected signage plate for display of information to passers-by and a system for selecting a signage plate from a plurality of pre-designed signage plates, it should be understood that many modifications, additions and deletions, in additions to those expressly recited, may be made thereto without departure from the spirit and scope of the invention as set forth in the appended claims.

1-8. (canceled)

9. A method for displaying a sign, comprising the steps of:
(a) selecting a sign from a plurality of pre-designed signs contained on a database that is accessed by a user having a computer that communicates with the signage database;
(b) selectively providing to the database user-supplied information for an information field associated with at least one of the pre-designed signs;
(c) printing on a local printer at least one copy of the selected sign including the user-supplied information in the information field if the selected sign is the one said sign;
(d) inserting the printed copy of the sign into a recessed portion of a panel; and
(e) positioning a support attached to the panel so that the panel stands in an erected position on a support surface for display of the printed sign in proximity to an area of relevance to the printed sign.

10. The method as recited in claim 9, wherein the step (e) positioning comprises moving the support from a retracted position to an extended position, so that the panel and support stand on the support surface in a substantially inverted “V” shape.

11. The method as recited in claim 10, wherein the support comprises a second panel that receives a second copy of the printed sign, for display of the information printed on the sign in opposing directions.

12. The method as recited in claim 9, wherein step (a) the computer communicates through an interactive network with the signage database.

13. The method as recited in claim 9, further comprising the step of overlying the printed sign with a protector sheet.

14. An A-frame apparatus for displaying a sign selectively obtained from a sign providing database in a sign system, comprising:
a pair of panels, each having a front and an opposing back, a bottom edge and a top edge;
each of the panels includes a recessed portion for receiving a signage plate containing information for display to passers-by and defining at least one opening therein for facilitating removal of the signage plate therefrom;
said signage plate comprises a selected one of a plurality of pre-designed signs maintained on an interactive database accessible by a user operating a computer that accesses the database through an interface and printed on a local printer, with at least one of the signs including an information field for receiving user-provided information; and
a pair of opposing projecting tabs, each tab extending towards the other tab from a respective portion of the panel and spaced-apart from a recessed surface of the recessed portion, the tabs restraining the signage plate within the recess;
the top edge of each panel defining a first portion and a second portion of a hingable connection, whereby the pair of panels hingedly interconnect by engaging the first portion of one panel with the second mating portion of the second panel,
the panels movable on the hinged connection from a first collapsed position with the panels juxtaposed in contacting relation to a second erected position with the panels defining an oblique angle, for standing of the apparatus as an A-frame on a support surface for display of the signage plate.

15. (canceled)

16. The A-frame apparatus as recited in claim 14, further comprising a cover sheet that overlies the signage plate received in the recessed portion.

17. A signage system, comprising:
a computerized sign selection apparatus having a database with a plurality of pre-designed signs for selection by a user communicating from a computer through an interface;
at least one of the signs including an information field that receives user-provided information communicated by the user;
printer means for generating a sheet bearing the selected sign, including the user-provided information if the selected sign is the one said sign; and
a sign holding device comprising:
a panel having a front and an opposing back, a bottom edge and a top edge;
the panel includes a recessed portion for receiving the sheet bearing the selected sign and defining at least one opening therein for facilitating removal of the sheet therefrom; and
a support attached to the panel and selectively positioned at an oblique angle relative to the panel for standing the sign holding device on a support surface,
whereby the sheet bearing the selected sign is disposed within the recessed portion and the sign holding device positioned on the support surface displays the selected sign.

18. The sign system as recited in claim 17, wherein the sign holding device further comprises at least a pair of opposing projecting tabs, each tab extending towards the other tab from a respective side edge of the panel and spaced-apart from a recessed surface of the recessed portion, the tabs restraining the signage plate within the recess; and at least one opening in the recessed portion, for facilitating removal of the sign therefrom.

19. The sign system of claim 17, wherein a top edge of the panel defines a portion of a hinge for connecting to a second hinge portion of the support, for hingedly engaging the support and the panel.

20. The sign system of claim 19, wherein the support comprises a second one of the panel.
